(19) United States
(12) Patent Application Publication
(10) Pub. No.: US 2004/0036655 A1
(43) Pub. Date: Feb. 26, 2004

(54) Multi-layer antenna structure

(76) Inventors: Robert Sainati, Bloomington, MN (US); Michael J Siegler, Eagan, MN (US)

Correspondence Address: SHUMAKER & SIEFFERT, P. A., 8425 SEASONS PARKWAY, SUITE 105, ST. PAUL, MN, 55125, US

(21) Appl. No.: 10/395,902

(22) Filed: Mar. 20, 2003

Related U.S. Application Data
(60) Provisional application No. 60/405,168, filed on Aug. 22, 2002.

(51) Int. Cl. H01Q 1/24; H01Q 9/28

(52) U.S. Cl. 343/702; 343/795

(57) ABSTRACT

The invention provides a multi-layer antenna structure for use in a wireless communication system. The antenna may be integrated within a multi-layer circuit structure such as a multi-layer printed circuit board. The multi-layer antenna structure may include, for example, a radiating component and a conductive strip feed-line that electromagnetically couples to the radiating component to directly feed the radiating component. The conductive strip feed-line may be fabricated to form a balun. The conductive strip feed-line may, for example, form a quarter-wavelength open circuit in order to realize the balun. The balun may perform signal transformations, e.g., unbalanced to balanced, as well as impedance transformations. The radiating component and the conductive strip feed-line forming the balun may be formed on different layers of a multi-layer circuit structure.

This application claims priority from U.S. Provisional Application Serial No. 60/405,168, filed Aug. 22, 2002, the entire content of which is incorporated herein by reference.

### TECHNICAL FIELD

The invention relates to antenna structures for use in a wireless communication system and, more particularly, to multi-layer antenna structures.

### BACKGROUND

With the advent of mobile computers, there has been an increased demand to link such devices in a wireless local area network (WLAN). A general problem in the design of mobile computers and other types of small, portable, wireless data communication products is the radiating structure required for the unit. An external dipole or monopole antenna structure can be readily broken in normal use. Also, the cost of the external antenna and its associated conductors can add to the cost of the final product.

In an effort to avoid use of an external antenna, manufacturers have begun to produce devices with embedded antennas. An embedded antenna is typically an antenna that is enclosed within a housing or case associated with the wireless card. For example, a wireless network card may include an antenna embedded within a printed circuit board of the wireless card. In this manner, the antenna forms an integral part of the product.

### SUMMARY

In general, the invention is directed to a multi-layer antenna structure for use in a wireless communication system. The multi-layer antenna structure may be integrated within a multi-layer circuit structure such as a multi-layer printed circuit board.

In accordance with the invention, a multi-layer antenna structure comprises a radiating component and a conductive strip feed-line that electromagnetically couples to the radiating component. In this manner, the conductive strip feed-line directly feeds the radiating component of the multi-layer antenna structure, in turn, eliminating the need for feed pins, soldering, or other connectors to attach the antenna structure to a multi-layer circuit structure. The radiating component and the conductive strip feed-line may be formed on different layers of a multi-layer circuit structure. For example, the radiating component may be formed on a first layer and the conductive strip feed-line associated with the radiating component may be formed on a second layer. The layers may be oriented to electromagnetically couple the conductive strip feed-line and the radiating component.

The conductive strip feed-line may be fabricated to form a balun. The conductive strip feed-line may, for example, form a quarter-wavelength open circuit in order to realize the balun. The balun transforms unbalanced (or single-ended) signals to balanced (or differential) signals and vice versa, i.e., balanced signals to unbalanced signals. For example, the balun formed by the conductive strip feed-line may receive an unbalanced signal from radio circuitry within the multi-layer circuit structure and induce a balanced signal on the radiating component of the multi-layer antenna structure. The balun may perform impedance transformations in addition to the signal transformations. In this manner, the multi-layer antenna structure eliminates the need for additional components for signal and impedance transformations.

The radiating component of the multi-layer antenna structure may be formed in the general shape of an arrow. The arrow shape of the radiating component provides the multilayer antenna structure with a broad beamwidth radiation pattern suitable for non-directional, free-space propagation. In this manner, the radiation pattern increases the transmission and reception capabilities of the antenna structure and is particularly well suited for wireless applications, such as wireless local area networking (WLAN). The arrow shape of the radiating component may further reduce the amount of surface area needed for fabrication of the multi-layer antenna structure within a multi-layer circuit structure.

In some embodiments, a multi-layer circuit structure may incorporate more than one multi-layer antenna structure. In this case, the multi-layer antenna structures may be spaced to provide the multi-layer circuit structure with receive diversity, transmit diversity, or both. The radiating components of the multi-layer antenna structures may be spaced relative to one another such that at least one of the radiating components of the antenna structures will be in a position where the signal has not experienced significant distortion from the multi-path effects, thereby offering spatial diversity. Alternatively, the radiating components may be configured to transmit and receive signals at different polarizations, e.g., left-hand circular and right hand circular polarizations, thereby achieving polarization diversity. Other diversity applications, such as frequency diversity, are also possible.

In one embodiment, the invention provides an antenna comprising a radiating component formed on a first layer of a multi-layer circuit structure and a conducting strip feed-line that electromagnetically couples to the radiating component formed on a second layer of the multi-layer circuit structure to directly feed the radiating component.

The invention may provide one or more advantages. Directly feeding the radiating component with a conductive strip that electromagnetically couples to the radiating element eliminates the need for feed pins, soldering or other connectors to attach a multi-layer antenna structure to a multi-layer circuit structure. In this manner, the multi-layer antenna structure reduces potential spurious radiation from the feed-line as well as parasitics associated with the balun feature. Further, by fabricating the conductive strip feed-line to form a balun, the cost of manufacturing wireless components that incorporate the multi-layer antenna structure may be reduced by not requiring additional components for signal and impedance transformations. The impedance matching and the signal transformations are performed within the antenna structure. The shape of the radiating component may provide the multi-layer antenna structure with a broad beamwidth radiation pattern suitable for non-directional free-space propagation and reduce the amount of surface area needed for fabrication of the multi-layer antenna structure within the multi-layer circuit structure. The dimensions of the radiating component may further be adjusted in order to attain an operating frequency of the antenna structure that conforms to various wireless standards such as the IEEE 802.11 (a), 802.11 (b), 802.11 (e) or 802.11 (g) standards.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a system for wireless communication.

FIG. 2 is a schematic diagram illustrating an exemplary multi-layer antenna structure in accordance with the invention.

FIG. 3 is a schematic diagram illustrating a wireless card for wireless communication that incorporates a plurality of multi-layer antenna structures.

FIG. 4 is an exploded view illustrating layers of a multi-layer circuit structure that includes a plurality multi-layer antenna structures.

FIG. 5 is a schematic view of the multi-layer circuit structure of FIG. 4 with the layers stacked on top of one another.

### DETAILED DESCRIPTION

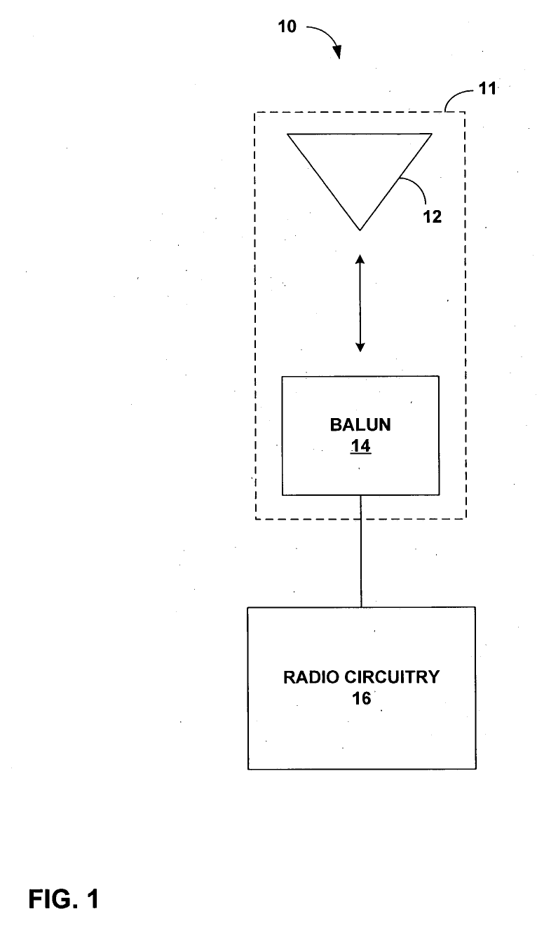

FIG. 1 is a block diagram illustrating a system 10 for wireless communication. System 10 includes a multi-layer antenna structure 11 that includes a radiating component 12 and a conductive strip feed-line (not shown) that electromagnetically couples to radiating component 12. As will be described, the conductive strip feed-line is fabricated to form a balun 14 that directly feeds radiating component 12. The conductive strip feed-line may, for example, electromagnetically couple to radiating component 12 using a quarter-wave open circuit in order to realize balun 14.

Balun 14 transforms unbalanced (or single-ended) signals to balanced (or differential) signals and vice versa, i.e., balanced signals to unbalanced signals. Balun 14 may perform impedance transformations in addition to conversions from balanced signals to unbalanced signals. In accordance with the invention, radiating component 12 and the conductive strip feed-line forming balun 14 reside on different layers of a multi-layer circuit structure. Radiating component 12 and balun 14 may, for example, reside on different layers of a multilayer printed circuit board.

In the example illustrated in FIG. 1, balun 14 couples multi-layer antenna structure 11 to radio circuitry 16. In this manner, balun 14 transforms balanced and unbalanced signals between antenna structure 11 and radio circuitry 16. For example, multi-layer antenna structure 11 may be a dipole antenna structure. In this case, balun 14 transforms balanced signals received by antenna structure 11 to unbalanced signals for radio circuitry 16. Further, balun 14 transforms unbalance signals from radio circuitry 16 to balanced signals for antenna structure 11 to transmit.

The diagram of FIG. 1 should be taken as exemplary of a type of device that balun 14 may couple to antenna structure 11, however, and not as limiting of the invention as broadly embodied herein. Multi-layer antenna structure 11 may couple to various other unbalanced devices via balun 14. For instance, balun 14 may couple multi-layer antenna structure 11 to other unbalanced components within the same multi-layer circuit structure.

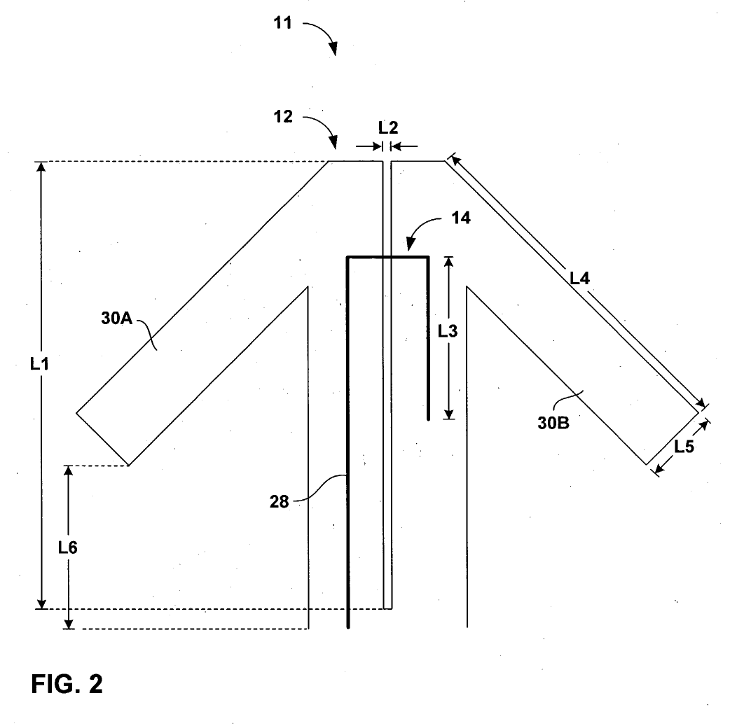

FIG. 2 is a schematic diagram illustrating an exemplary multi-layer antenna structure 11 in accordance with the invention. As described above, multi-layer antenna structure 11 includes a radiating component 12 and a conductive strip feed-line 28 that electromagnetically couples to radiating component 12. Conductive strip feed-line 28 is fabricated to form a balun 14. For example, conductive strip feed-line 28 may be fabricated to form a quarter-wave open circuit, as illustrated in FIG. 2, in order to realize balun 14. Radiating component 12 comprises radiating elements 30A and 30B (“radiating elements 30”). Radiating elements 30 are referenced to a ground plane, i.e., carry the same potential as the ground plane. Radiating elements 30 may, for example, be dipole arms of a dipole antenna.

Conductive strip feed-line 28 directly feeds radiating component 12 and, more particularly, radiating elements 30. In general, the term “directly feed” refers to the electromagnetic coupling between conductive strip feed-line 28 and radiating component 12. Directly feeding radiating component 12 with conductive strip feed-line 28 eliminates the need for feed pins, soldering, or other connectors to attach antenna structure 11 to a multi-layer circuit structure. In this manner, multi-layer antenna structure 11 reduces potential spurious radiation from the feed-line as well as parasitics associated with the balun feature.

Conductive strip feed-line 28 may be formed by any of a variety of fabrication techniques. For instance, printing techniques may be used to deposit a conductive trace, e.g., conductive strip feed-line 28, on a dielectric layer. Alternatively, a conductive layer (not shown) may be deposited on a dielectric layer and shaped, e.g., by etching, to form balun 14. More specifically, the conductive layer may be deposited on the dielectric layer using techniques such as chemical vapor deposition and sputtering. The conductive layer deposited on the dielectric layer may be shaped via etching, photolithography, masking, or a similar technique to form balun 14.

Balun 14 formed by conductive strip feed-line 28 can transform unbalanced signals to balanced signals and vice versa, i.e., balanced signals to unbalanced signals. More specifically, conductive strip feed-line 28 may, for example, receive an unbalanced signal from another component of a multi-layer circuit structure, such as radio circuitry 16. Electromagnetic coupling between conductive strip feed-line 28 and radiating component 12 induce a signal on radiating component 12.

Because of the shape of conductive strip feed-line 28, e.g., the quarter-wavelength open circuit formed by conductive strip feed-line 28, the signal induced on radiating component 12 is a balanced signal. In particular, one of radiating elements 30, i.e., radiating element 30B, electromagnetically couples a portion of conductive strip feed-line 28 that forms a stub portion of the quarter-wavelength open circuit.

The current on the stub portion of the quarter-wavelength open circuit is opposite the current on the rest of conductive strip feed-line 28, in turn, causing the signals induced on radiating elements 30A and 30B to have the same magnitude and a 180-degree phase difference, i.e., be balanced signals. Signal flow also occurs in the opposite direction. Each radiating component 12 receives a balanced signal and electromagnetically induces an unbalanced signal in conductive strip feed-line 28.

In this manner, conductive strip feed-line 28 forms balun 14 that transforms received signals from balanced to unbalanced signals and vice versa. Balun 14 may be configured to perform impedance transformations in addition to converting between balanced signals and unbalanced signals. Conductive strip feed-line 28 forming balun 14 may reduce the cost of manufacturing wireless components that incorporate multi-layer antenna structure 11 by not requiring additional components for signal and impedance transformations.

As illustrated in FIG. 2, radiating component 12 is formed generally in the shape of an arrow. However, radiating component 12 may be formed in any shape. For example, radiating component 12 may be formed in the shape of the letter ‘T’ or ‘Y’. The arrow shape of radiating component 12 illustrated in FIG. 2 may nevertheless have some advantages over other shapes such as the Y-shape or T-shape. The arrow shape of radiating component 12 may provide multi-layer antenna structure 11 with a broad beamwidth radiation pattern suitable for non-directional free-space propagation. In this manner, the radiation pattern increases the transmitting and receiving capabilities of multi-layer antenna structure 11 and is particularly well suited for many wireless applications, such as wireless local area networking (WLAN). The arrow shape of radiating component 12 may further reduce the amount of surface area needed for fabrication of multi-layer antenna structure 11 within a multi-layer circuit structure.

A set of dimensions L1-L6 of multi-layer antenna structure 11 allow multi-layer antenna structure 11 to be tuned to a particular operating frequency range to conform to standards such as the IEEE 802.11 (a), 802.11 (b), 802.11 (e) or 802.11 (g) standards. Varying dimensions L1-L6 may further provide flexibility in impedance matching. Dimensions L1-L6 include a balun slot length L1, a balun slot width L2, a conductive strip feed-line open circuit stub length L3;, a radiating element length L4, a radiating element width L5, and a distance from the radiating element to ground L6.

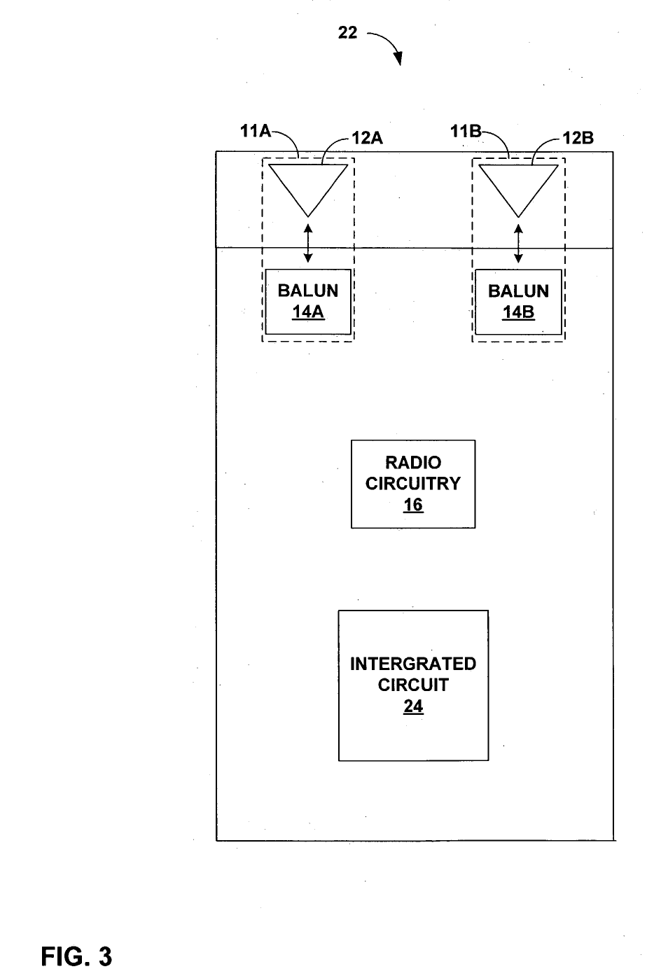

FIG. 3 is a schematic diagram illustrating a wireless card 22 for wireless communication. Wireless card 22 includes multi-layer antenna structures 11A and 11B (“multi-layer antenna structures 11”) , radio circuitry 16 and an integrated circuit 24. Multi-layer antenna structures 11 comprise radiating components 12A and 12B (“radiating components 12”) and conductive strip feed-lines (not shown) that form baluns 14A and 14B (“baluns 14”).

Multi-layer antenna structures 11 receive and transmit signals to and from wireless card 22. Multi-layer antenna structures 11 may, for example, receive signals over multiple receive paths providing wireless card 22 with receive diversity. In this manner, multi-layer antenna structure 11A provides a first receive path, and multi-layer antenna structure 11B provides a second receive path.

Wireless card.22 may select, via radio circuitry 16, the receive path with the strongest signal. Alternatively, wireless card 22 and, more particularly, radio circuitry 16 may combine the signals from the two receive paths. More than two multi-layer antenna structures 11 may be provided in some embodiments for enhanced receive diversity. Alternatively, only a single multi-layer antenna structure 11 may be provided in which case wireless card 22 does not make use of receive diversity. One or both of multi-layer antenna structures 11 may further be used for transmission of signals from wireless card 22.

Radio circuitry 16 may include transmit and receive circuitry (not shown). For example, radio circuitry 16 may include circuitry for upconverting transmitted signals to radio frequency (RF), and downconverting RF signals to a baseband frequency for processing by integrated circuit 24. In this sense, radio circuitry 16 may integrate both transmit and receive circuitry within a single transceiver component. In some cases, however, transmit and receive circuitry may be formed by separate transmitter and receiver components.

Baluns 14 couple multi-layer antenna structures 11 and, more particularly, radiating components 12 with radio circuitry 16. Specifically, balun 14A couples radiating component 12A with radio circuitry 16 and balun 14B couples radiating component 12B with radio circuitry 16. Baluns 14 may transform unbalanced (or single-ended) signals from radio circuitry 16 to balanced (or differential) signals for multi-layer antenna structures 11 and vice versa, i.e., balanced signals from multi-layer antenna structures 11 to unbalanced signals for radio circuitry 16. Baluns 14 may perform impedance transformations in addition to conversions from balanced signals to unbalanced signals.

Integrated circuit 24 processes inbound and outbound signals. Integrated circuit 24 may, for instance, encode information in a baseband signal for upconversion to the RF band or decode information from RF signals received via antennas 14. For example, integrated circuit 24 may provide Fourier transform processing to demodulate signals received from a wireless communication network. Although in the example illustrated in FIG. 3 radio circuitry 16 and integrated circuit 24 are discrete components, wireless card 22 may incorporate a single component that integrates radio circuitry 16 and integrated circuit 24.

Multi-layer antenna structures 11 reside within multiple layers of a multi-layer circuit structure. Multi-layer antenna structures 11 may, for example, be formed within multiple layers of a printed circuit board. As described above, baluns 14 and radiating components 12 reside on different layers of a multi-layer circuit structure. Conductive strip feed-lines fabricated on a dielectric substrate may form baluns 14 and electromagnetically couple to a respective one of radiating components 12. In this manner, the conductive strip feed-lines directly feed radiating components 12 of multi-layer antenna structures 11.

Wireless card 22 illustrated in FIG. 3 should be taken as exemplary of the type of device in which the invention may be embodied, however, and not as limiting of the invention as broadly embodied herein. For example, the invention may be practiced in a wide variety of devices, including RF chips, WLAN cards, cellular phones, personal computers (PCs), personal digital assistants (PDAs), and the like. As a particular example, wireless card 22 may take the form of a wireless local area networking (WLAN) card that conforms to a WLAN standard such as one or more of the IEEE 802.11 (a), 802.11 (b), 802.11 (e) or 802.11 (g) standards.

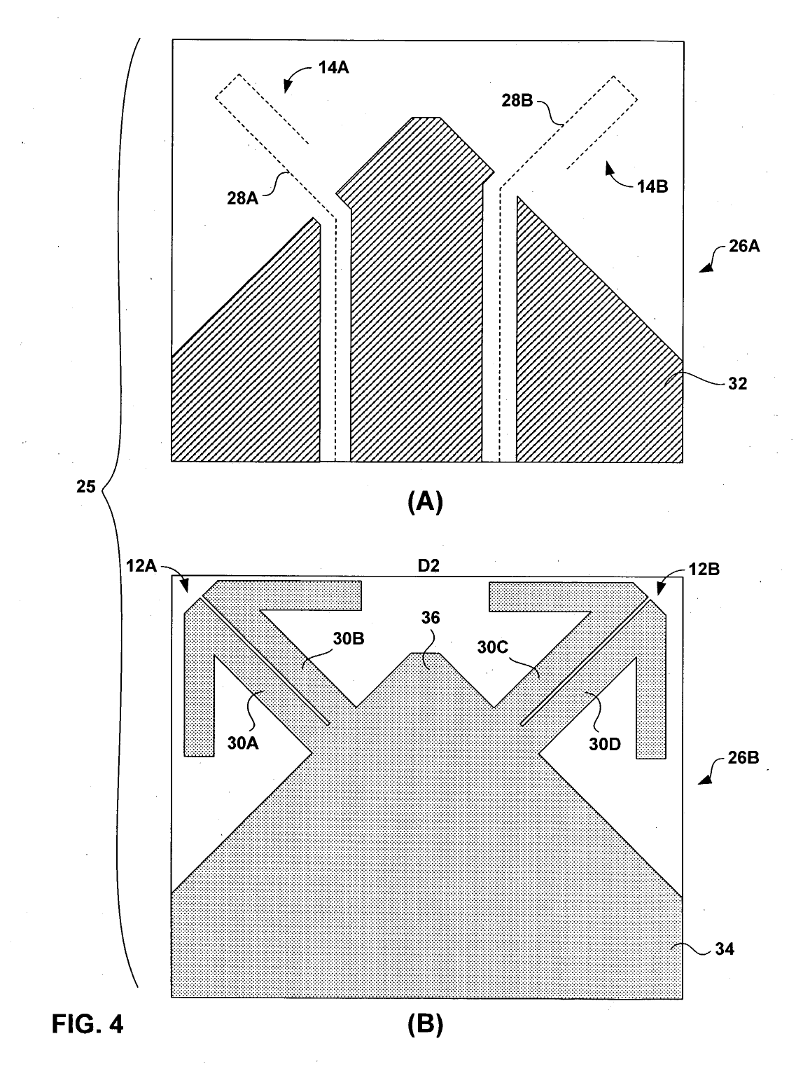

FIG. 4 is an exploded view illustrating layers 26A and 26B (“layers 26”) of a multi-layer circuit structure 25, such as wireless card 22 of FIG. 3, in more detail. FIG. 4(A) illustrates a first layer 26A of multi-layer circuit structure 25, which includes conductive strip feed-lines 28A and 28B (“conductive strip feed-lines 28”). FIG. 4(B) illustrates a second layer 26B of multi-layer circuit structure 25, which includes radiating components 12A and 12B (“radiating components 12”).

As described above, conductive strip feed-lines 28A and 28B may be fabricated to form baluns 14A and 14B (“baluns 14”), respectively. Conductive strip feed-lines 28 may, for example, be fabricated to form a quarter-wavelength open circuit in order to realize baluns 14. Conductive strip feed-lines 28 may be fabricated, for example, using printing or other deposition techniques. Alternatively, conductive strip feed-lines 28 may be fabricated using other fabrication techniques including chemical vapor deposition, sputtering, etching, photolithography, masking, and the like.

Conductive strip feed-lines 28 may extend from another component within multi-layer circuit structure 25, such as radio circuitry 16, and directly feed radiating components 12. As described above, directly feeding radiating components 12 with conductive strip feed-lines 28 eliminates the need for feed pins, soldering, or other connectors to attach antenna structures 11 to the multi-layer circuit structure. In this manner, multi-layer antenna structures 11 reduce potential spurious radiation from the feed-lines as well as parasitics associated with the balun feature.

FIG. 4(B) illustrates second layer 26B that includes radiating components 12 to transmit and receive signals. More particularly, each of radiating components 12 includes one or more radiating elements 30. For example, radiating component 12A includes radiating elements 30A and 30B. In the example of FIG. 4, radiating elements 30A-30D form arms of radiating component 14 of a dipole antenna.

Radiating elements 30 are referenced to a ground plane 34, i.e., carry a potential relative to ground plane 34. For instance, radiating elements 30 may be formed from ground plane 34, may be mounted on ground plane 34, or may otherwise electrically couple to ground plane 34. In the example of FIG. 4, radiating elements 30 are formed from ground plane 34. Ground plane 34 from which radiating elements 30 are formed extends partially between radiating components 12. In other words, an edge 36 of ground plane 34 extends between radiating element 30B of radiating component 12A and radiating element 30C of radiating component 12B. However, edge 36 of ground plane 34 does not extend all the way between antennas 14, i.e., does not completely separate radiating components 12 because of the close proximity of radiating components 12A and 12B. In some embodiments, however, the ground plane may extend all the way between antennas 14.

Each of radiating components 12 is electromagnetically coupled to a respective one of conducting strip feed-lines 28 and, in turn, baluns 14. More particularly, radiating component 12A is electromagnetically coupled to conducting strip feed-line 28A that forms balun 14A while radiating component 12B is electromagnetically coupled to conducting strip feed-line 28B that forms balun 14B. In this manner, conductive strip feed-lines 28 that form baluns 14 directly feed radiating components 12.

In operation, conductive strip feed-lines 28 carry an unbalanced signal from an unbalanced component within multi-layer circuit structure 25, such as radio circuitry 16. Electromagnetic coupling between conductive strip feed-lines 28 and radiating components 12 as well as the quarter wave open circuit formed by conductive strip feed-lines 28 induce a balanced signal on radiating components 12. More specifically, using radiating component 12A and conductive strip feed-line 28A as an example, radiating element 30A electromagnetically couples a non-stub portion of the quarter-wavelength open circuit formed by conductive strip feed-line 28A and radiating element 30B electromagnetically couples a stub portion of the quarter-wavelength open circuit.

The electromagnetic coupling induces a balanced signal on radiating elements 30A and 30B. Specifically, because the current on the stub portion of the quarter-wavelength open circuit coupling, i.e., the portion coupling to radiating component 30B, is opposite the current of the non-stub portion of the quarter-wavelength open circuit coupling to radiating element 30A the signals induced on radiating elements 30A and 30B have the same magnitude and a 180-degree phase difference. Signal flow also occurs in the opposite direction, e.g., each radiating component 12 receives a balanced signal and electromagnetically induces an unbalanced signal on conductive strip feed-lines 28.

Conductive strip feed-lines 28 may further perform impedance transformations in addition to signal transformations. More particularly, the impedance transformation occurs due to conductive strip feed-lines 28 referencing different ground planes. For example, a portion of conductive strip feed-line 28A references a ground plane 32 and another portion of conductive strip feed-line 28A references ground plane 34. The portion of conductive strip feed-line 28A referencing ground plane 32 has a first impedance and the portion of conductive strip feed-line 28B referencing ground plane 34 has a second impedance. The different impedances occur due to the distance between conductive strip feed-line 28A and the respective ground plane. Specifically, conductive strip feed-line 28A is in closer proximity to ground plane 32 than ground plane 34. The impedance transformation from the first impedance to the second impedance occurs at the point in which conductive strip feed-line 28A changes ground plane references from ground plane 32 to ground plane 34.

Radiating components 12 of FIG. 4 are formed in the shape of an arrow. The arrow shape of radiating components 12 provides multi-layer antenna structures 11 with a broad beamwidth radiation pattern suitable for non-directional free-space propagation. In this manner, the radiation pattern increases the transmitting and receiving capabilities of the multi-layer circuit structure and is particularly well suited for WLAN applications. However, as described above, radiating components 12 may be formed in other shapes such as a T-shape, Y-shape, and the like.

Radiating components 12 of multi-layer antenna structures 11 may be spaced to provide the multi-layer circuit structure with receive diversity. Receive diversity reduces problems encountered from multi-path propagation, such as destructive interference caused by traveling paths of different lengths. The multi-layer circuit structure may, for example, have receive circuitry within radio circuitry 16 select the signal from the antenna structure 11 that receives the strongest signal.

Radiating components 12 of multi-layer antenna structures 11 may be spaced relative to one another such that at least one of radiating components 12 of antenna structures 11 will be in a position where the signal has not experienced significant distortion from the multi-path effects, which is referred to as spatial diversity. Alternatively, radiating components 12 may be configured to transmit and receive signals at different polarizations, e.g. left-hand circular polarization for radiation element 12A and right hand circular polarization for radiation element 12B, thereby achieving polarization diversity. Other diversity applications, such as frequency diversity, are also possible.

As illustrated in FIG. 4, layers 26A and 26B may be oriented such that conductive strip feed-lines 28 are substantially aligned with a length of radiating component 12 to provide the electromagnetic coupling. More particularly, conductive strip feed-lines 28 form a quarter-wavelength open circuit in which one of the sides of the quarter-wavelength open circuit, e.g., the stub side, aligns with one of the radiating elements 30 of radiating component 12 and the other side of the quarter-wavelength open circuit aligns with one of the other radiating element 30 of radiating component 12.

Although in the example illustrated in FIG. 4 the layer with conductive strip feed-lines 28, i.e., layer 26A, is on top of the layer with radiating components 12, i.e., layer 26B, the layering may be reversed. For example, layer 26B may be on top of layer 26A. Further, one or more layers may be interspersed between layers 26A and 26B. For example, a layer that includes conductive traces for other components of the multi-layer circuit structure may be interspersed between layers 26A and 26B.

A process for creating a multi-layer antenna structure 11 in accordance with the invention will now be described. Initially, a radiating component is formed on a first layer of a multi-layer circuit structure. The radiating component may be formed by forming one or more radiating elements that are referenced to a ground plane, i.e., have the same potential as the ground plane. The radiating component may be formed with certain dimensions in order to be tuned to a particular operating frequency range to conform to standards such as the IEEE 802.11 (a), 802.11 (b), 802.11 (e) or 802.11 (g) standards. For example, the radiating component may be formed with a particular balun slot length, balun slot width, radiating element length, radiating element width, and distance between the radiating element and ground plane.

In the case in which more than one multi-layer antenna structure is utilized, other radiating components are also formed. The plurality of radiating components may be spaced relative to one another in order to achieve spatial diversity. The radiating components may further be configured to transmit and receive signals at different polarizations thereby achieving polarization diversity. In some embodiments, each radiating component may have different dimensions in order to be tuned to slightly different operating frequency ranges to achieve frequency diversity.

Next, a conducting strip feed-line is formed on a second layer of the multi-layer circuit structure. The conductive strip feed-line electromagnetically couples to the radiating component to directly feed the radiating component. The conductive strip feed-line is formed in order to realize a balun. The conductive strip feed-line may, for example, form a quarter-wavelength open circuit in order to realize the balun. The balun formed by the conductive strip feed-line transforms signals between unbalanced and balanced signals as well as performing impedance transformations. In the embodiment in which the multi-layer circuit structure utilizes a plurality of multi-layer antenna structures, a plurality of conductive strip feed-lines are formed, each feed-line electromagnetically coupling to a respective radiating component to directly feed the radiating component.

The conductive strip feed-line may be formed using various fabrication techniques. The conductive strip feed-line may, for example, be printed onto a dielectric layer. Alternatively, a conductive layer, such as copper, aluminum, or other conductive material, may be deposited, for instance, on a dielectric layer. The conductive layer may be deposited on the dielectric layer via chemical vapor deposition, sputtering, or any other depositing technique. The conductive layer may be shaped via etching, photolithography, masking, or similar technique to form the first unbalanced and balanced components.

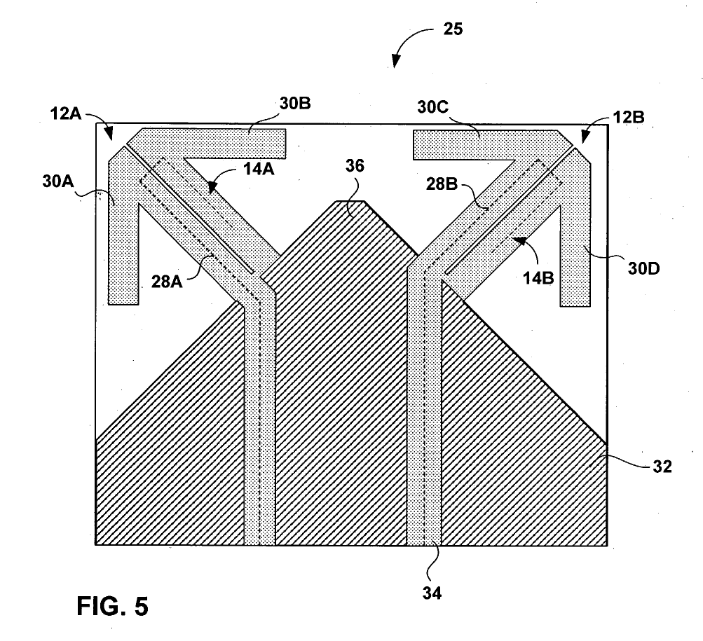

FIG. 5 is a schematic diagram illustrating multi-layer circuit structure 25 with layer 26A imposed on top of layer 26B. As described above, conductive strip feed-lines 28A and 28B electromagnetically couple to radiating components 12A and 12B, thus directly feeding radiating components 12A and 12B, respectively. In alternate embodiments, layer 26B may be imposed on top of layer 26A.

Various embodiments of the invention have been described. These and other embodiments are within the scope of the following claims.

1. An antenna comprising:
a radiating component to transmit and receive signals; and
a conductive strip feed-line that electromagnetically couples to the radiating component to directly feed the radiating component.

2. The antenna of claim 1, wherein the radiating component is disposed on a first layer of a multi-layer circuit structure, and the conductive strip feed-line is disposed on a second layer of the multi-layer circuit structure.

3. The antenna of claim 2, further comprising one or more intermediate layers to separate the first and second layers.

4. The antenna of claim 1, wherein the radiating component includes:
a first radiating element that electromagnetically couples a first portion of the conductive strip feed-line; and
a second radiating element that electromagnetically couples a second portion of the conductive strip feed-line.

5. The antenna of claim 4, wherein the first portion of the conductive strip feed-line induces a first signal on the first radiating component and the second portion of the conductive strip feed-line induces a second signal on the second radiating component, the second signal having substantially the same magnitude as the first signal and approximately a 180-degree phase difference from the first signal.

6. The antenna of claim 4, wherein the conductive strip feed-line forms a quarter-wavelength open circuit that includes a stub portion, and the first radiating component electromagnetically couples the stub portion of the quarter-wavelength open circuit.

7. The antenna of claim 1, further comprising a plurality ground planes, wherein a first portion of the conductive strip feed-line references a first one of the ground planes and a second portion of the conductive strip feed-line references a second one of the ground planes to achieve impedance transformations.

8. The antenna of claim 1, wherein the radiating component comprises an arrow shaped radiating component.

9. The antenna of claim 1, wherein the radiating component comprises one of a T-shaped radiating component and a Y-shaped radiating component.

10. The antenna of claim 1, further comprising a ground plane, the radiating component carrying a potential relative to the ground plane.

11. The antenna of claim 10, wherein the radiating component is formed from the ground plane.,

12. A wireless device comprising:
a first antenna;
a second antenna, the first and second antennas each including a radiating component and a conductive strip feed-line that electromagnetically couples to the radiating component to directly feed the radiating component; and
radio circuitry that receives signals via at least one of the first and second antennas.

13. The wireless device of claim 12, wherein the radio circuitry transmits signals via at least one of the first and second antennas.

14. The wireless device of claim 12, further comprising an integrated circuit to process the received signals.

15. The wireless device of claim 12, wherein the radiating component is disposed on a first layer of a multi-layer circuit structure, and the conductive strip feed-line is disposed on a second layer of the multi-layer circuit structure.

16. The wireless device of claim 12, wherein the radiating component includes:
a first radiating element that electromagnetically couples a first portion of the conductive strip feed-line; and
a second radiating element that electromagnetically couples a second portion of the conductive strip feed-line.

17. The wireless device of claim 16, wherein the conductive strip feed-line forms a quarter-wavelength open circuit that includes a stub portion, and the first radiating component electromagnetically couples the stub portion of the quarter-wavelength open circuit.

18. The wireless device of claim 12, wherein the radiating component comprises an arrow shaped radiating component.

19. The wireless device of claim 12, wherein the first and second antennas are spaced a fraction of a wavelength apart from one another to achieve spatial diversity.
